(19) United States
(12) Patent Application Publication
(10) Pub. No.: US 2013/0169538 A1
(43) Pub. Date: Jul. 4, 2013

(54) MOUSE WITH DETACHABLE OPERATING MODULE

(71) Applicant: Chun-Che Wu, Taipei (TW)

(72) Inventor: Chun-Che Wu, Taipei (TW)

(73) Assignee: PRIMAX ELECTRONICS LTD., Taipei (TW)

(21) Appl. No.: 13/463,520

(22) Filed: May 3, 2012

(30) Foreign Application Priority Data
Jan. 2, 2012 (TW) 101100044

(51) Int. Cl. G06F 3/033

(52) U.S. Cl. 345/163

(57) ABSTRACT

A mouse with a detachable operating module is provided. The mouse includes a mouse body and a functional device. The functional device includes the operating module and a connecting part. The connecting part is extended from the operating module. The functional device detachably connected with the mouse body through the connecting part. According to the user's requirements, the functional device may be replaced with another functional device having another function.

### FIELD OF THE INVENTION

The present invention relates to a mouse, and more particularly to a mouse with a detachable operating module, so that the operating module may be detached and replaced by a user.

### BACKGROUND OF THE INVENTION

With increasing development of science and technology and with the coming of the digital age, personal computers have become important working, learning and entertaining tools for most users. In addition, a mouse is one of the most popular computer input devices. The mouse can be used as a cursor control device for moving a cursor shown on a window of a display screen. Moreover, the user may press down click buttons of the mouse to trigger corresponding switches, thereby issuing various commands to the personal computer. Since the personal computer is frequently used, the demands on the mouse are gradually increased. In the early stage, the mouse only has a left click button and a right click button. Nowadays, the mouse is additionally equipped with a scroll wheel and other functional devices. In practice, when the fabricating cost and other causes are taken into consideration, these functional devices fail to be completely installed on the mouse. In different conditions, the functional devices should be replaced with other ones according to different requirements.

For example, in a case that a computer game is played by the user, a joystick may be operated to facilitate controlling operations of the computer game. Consequently, a joystick and a mouse may be integrated into an integrated mouse device. Whereas, in a case that a computer graphics software is executed, a trackball or a touchpad may be used to assist in positioning the cursor. Consequently, a trackball or a touchpad and a mouse may be integrated into an integrated mouse device. However, some drawbacks may occur. For example, if the software is changed, the overall integrated mouse device should be replaced with a new one. As know, the process of replacing the integrated mouse device is very troublesome. In addition, the one-piece integrated mouse device is not cost-effective. Moreover, if the user has many integrated mouse devices, a lot of space is required to accommodate these integrated mouse devices. Under this circumstance, the anticipated operated convenience fails to be achieved. Instead, so many integrated mouse devices bring about trouble matters. From the above discussions, the function devices for the conventional integrated mouse device fail to be suitably changed according to the practical requirements.

Therefore, there is a need of providing a mouse with replaceable functional devices according to the practical requirements.

### SUMMARY OF THE INVENTION

The present invention provides a mouse with a detachable operating module. Since a detachable functional device may be integrated into a mouse body, the function device with a desired function may be connected with the mouse body according to the practical requirements.

In accordance with an aspect of the present invention, there is provided a mouse with a detachable operating module. The mouse includes a mouse body and a functional device. The mouse body includes a circuit board. The functional device includes the operating module and a connecting part. The operating module has a conductive part. The connecting part is extended from the operating module, and detachably connected with the mouse body. When the connecting part of the functional device is connected with the mouse body, the conductive part of the operating module is electrically connected with the circuit board.

In an embodiment, the connecting part is a bottom cover, which is engaged with a bottom of the mouse body.

In an embodiment, the circuit board has a conductive resilient strip. When the connecting part is connected with the mouse body, the conductive part is in contact with the conductive resilient strip of the circuit board.

In an embodiment, the mouse body further includes a plurality of operating members, the circuit board further includes a plurality of switches, and the plurality of operating members are operated to trigger corresponding switches.

In an embodiment, the operating module and the mouse body are arranged side by side, so that the operating members and the operating module are simultaneously exposed.

In an embodiment, the operating module is a trackball device.

In an embodiment, the operating module is a control rod.

In an embodiment, the operating module is a touchpad.

In an embodiment, the operating module is a solar energy charging pad.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic perspective view illustrating a mouse with a detachable operating module according to a first embodiment of the present invention;

FIG. 2 is a schematic exploded view illustrating a mouse with a detachable operating module according to the first embodiment of the present invention;

FIG. 3 is a schematic perspective view illustrating a mouse with a detachable operating module according to a second embodiment of the present invention;

FIG. 4 is a schematic perspective view illustrating a mouse with a detachable operating module according to a third embodiment of the present invention; and

FIG. 5 is a schematic perspective view illustrating a mouse with a detachable operating module according to a fourth embodiment of the present invention.

### DETAILED DESCRIPTION OF THE PREFERRED EMBODIMENT

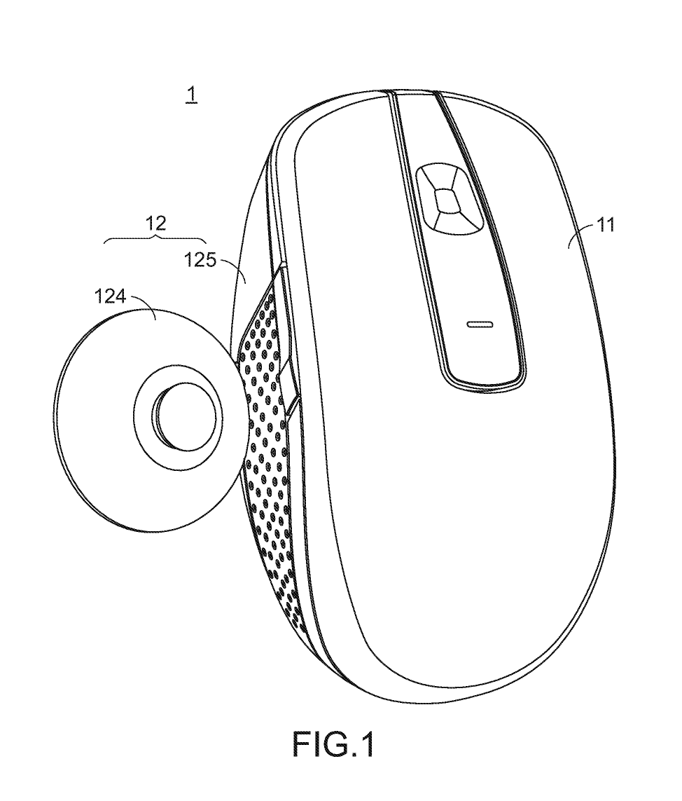

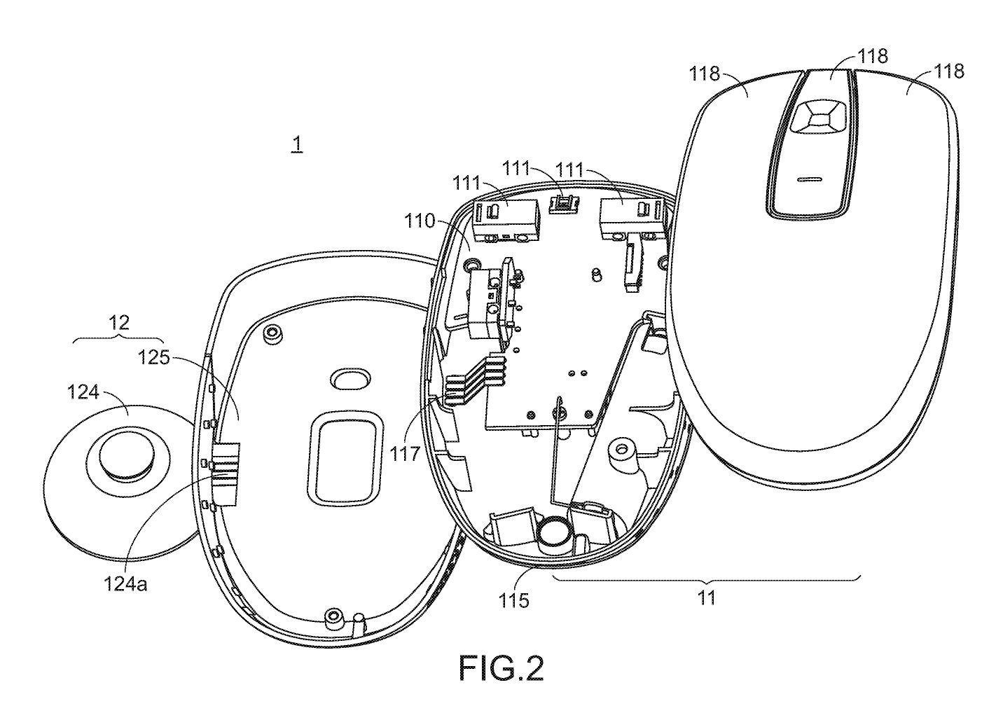

FIG. 1 is a schematic perspective view illustrating a mouse with a detachable operating module according to a first embodiment of the present invention. FIG. 2 is a schematic exploded view illustrating a mouse with a detachable operating module according to the first embodiment of the present invention. As shown in FIG. 1, the mouse 1 comprises a mouse body 11 and a functional device 12. The functional device 12 is detachably connected with the mouse body 11. According to the user's requirements, the functional device 12 with a desired function may be selectively connected with the mouse body 11. Consequently, in addition to the basic mouse structure (e.g. the plurality of click buttons and the scroll wheel), the mouse will have an additional special function.

Please refer to FIG. 2. The functional device 12 comprises an operating module 124 and a connecting part 125. The operating module 124 is selected from one of various computer peripheral devices. An example of the operating module 124 includes but is not limited to a control rod, a trackball device, a touchpad or a solar energy charging pad. In addition, the connecting part 125 of the functional device 12 is extended from the operating module 124 toward the mouse body 11 so as to be connected with the mouse body 11. The connecting part 125 of the functional device 12 may be connected with the mouse body 11 through a screwing means, a fastening means or any other detachably-coupling means.

Please refer to FIG. 2 again. The mouse body 11 comprises a circuit board 110 and a plurality of operating members 118. The operating members 118 may be operated to trigger corresponding switches 111 on the circuit board 110. That is, by depressing one of the operating members 118 of the mouse body 11, a corresponding control command is generated. An example of the operating member 118 includes but is not limited to a click button or scroll wheel. Moreover, the operating module 124 further comprises a conductive part 124a for transmitting an electric current. When the connecting part 125 of the functional device 12 is connected with the mouse body 11, the conductive part 124a is in contact with a conductive resilient strip 117, so that the connecting part 125 is electrically connected with the mouse boy 11. In such way, the electric power from the mouse body 11 may be acquired by the operating module 124, so that the operating module 124 is operable by the user.

Please refer to FIGS. 1 and 2 again. In this embodiment, the connecting part 125 of the functional device 12 is a bottom cover. After the bottom cover is engaged with the bottom of the mouse body 11, the functional device 12 is smoothly connected with the mouse body 11. In addition, the operating module 124 and the mouse body 11 are arranged side by side, so that the operating module 124 and the operating members 118 of the mouse body 11 are simultaneously exposed outside. When the operating members 118 are clicked or scrolled by the user, the functional device 12 beside the mouse body 11 may be additionally operated by the user's finger. Consequently, in addition to the original functions, the mouse 1 with the detachable operating module 124 will have expanded functions.

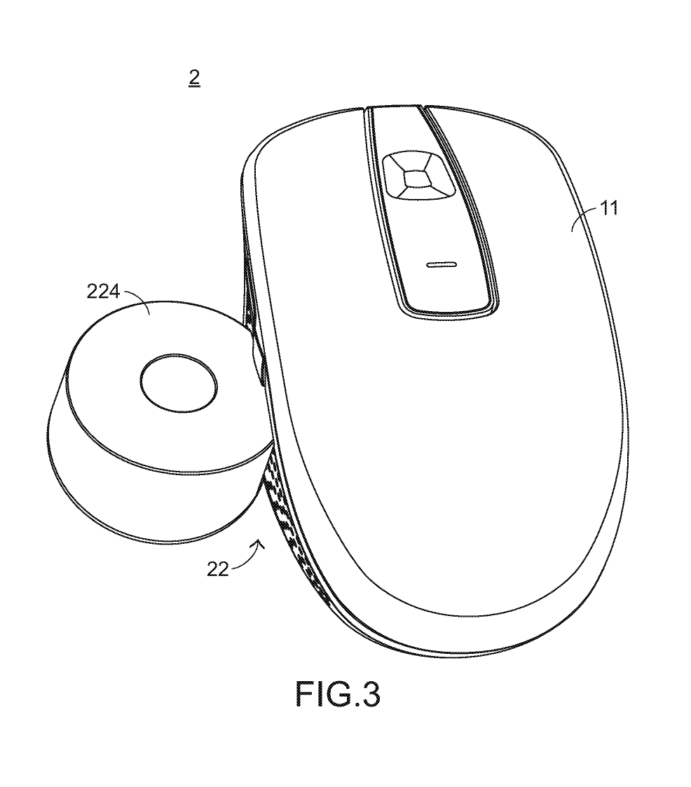

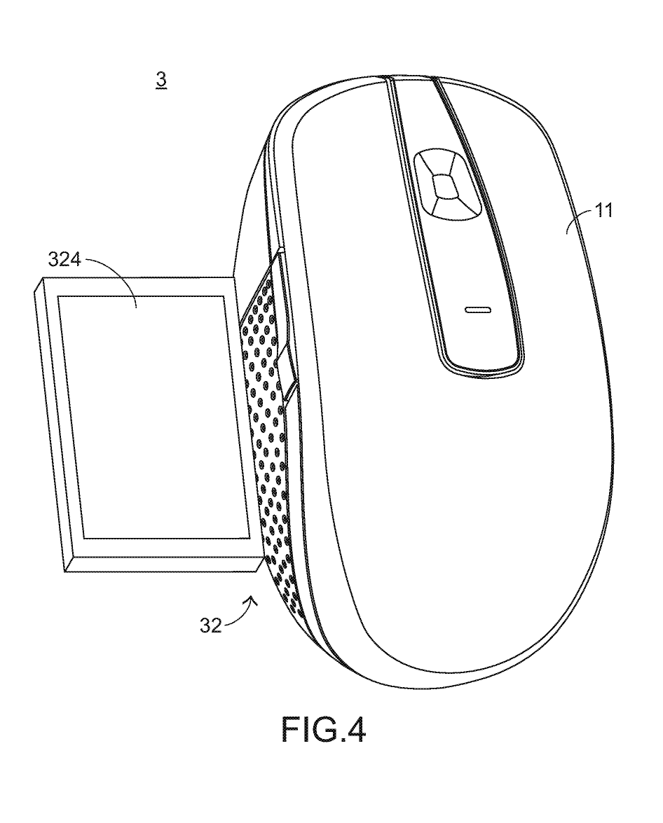

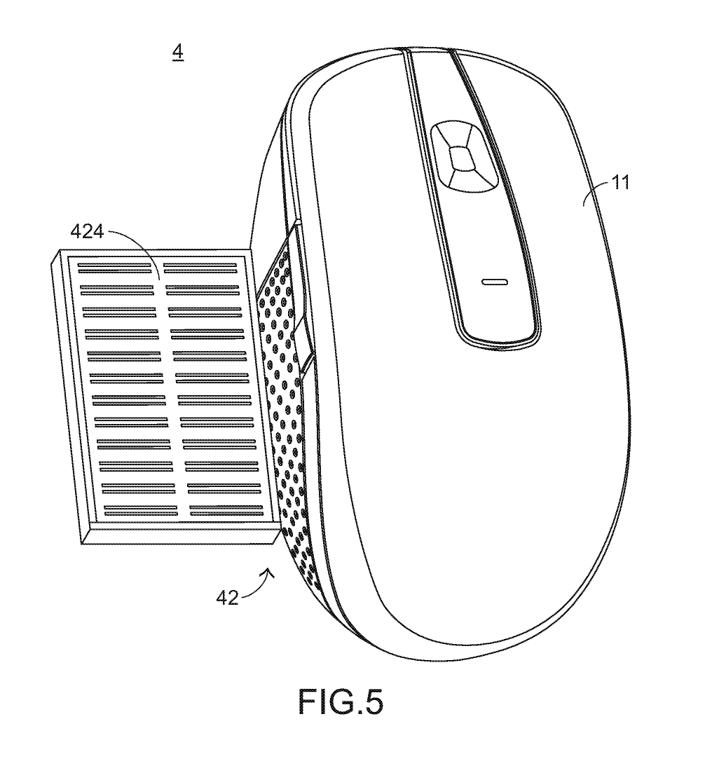

FIG. 3 is a schematic perspective view illustrating a mouse with a detachable operating module according to a second embodiment of the present invention. FIG. 4 is a schematic perspective view illustrating a mouse with a detachable operating module according to a third embodiment of the present invention. FIG. 5 is a schematic perspective view illustrating a mouse with a detachable operating module according to a fourth embodiment of the present invention. Except for the following items, the configurations of other components of the mouse body 11 included in each of the three embodiments are similar to those of the first embodiment, and are not redundantly described herein. In comparison with the first embodiment, the functional device 22 of the mouse 2 of the second embodiment (see FIG. 3) has an operating module 224. The operating module 224 is a trackball device. The trackball device is electrically connected with the mouse body 11 for acquiring the electric power from the mouse body 11. In comparison with the first embodiment, the functional device 32 of the mouse 3 of the third embodiment (see FIG. 4) has an operating module 324. The operating module 324 is a touchpad. The touchpad 324 is electrically connected with the mouse body 11 for acquiring the electric power from the mouse body 11. In comparison with the first embodiment, the functional device 42 of the mouse 4 of the fourth embodiment (see FIG. 5) has an operating module 424. The operating module 424 is a solar energy charging pad. The solar energy charging pad is electrically connected with the mouse body 11 for acquiring the electric power from the mouse body 11.

From the above description, the present invention provides a mouse with a detachable operating module. According to the practical requirements, a functional device with a desired function may be selectively connected with the mouse body. Consequently, the performance and convenience of the mouse will be largely expanded.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A mouse with a detachable operating module, said mouse comprising:
a mouse body comprising a circuit board; and
a functional device comprising:
said operating module having a conductive part; and
a connecting part extended from said operating module, and said connecting part detachably connected with said mouse body,
wherein when said connecting part of said functional device is connected with said mouse body, said conductive part of said operating module is electrically connected with said circuit board.

2. The mouse according to claim 1, wherein said connecting part is a bottom cover, which is engaged with a bottom of said mouse body.

3. The mouse according to claim 1, wherein said circuit board has a conductive resilient strip, wherein when said connecting part is connected with the mouse body, said conductive part is in contact with said conductive resilient strip of said circuit board.

4. The mouse according to claim 1, wherein said mouse body further comprises a plurality of operating members, said circuit board further comprises a plurality of switches, and said plurality of operating members are operated to trigger corresponding switches.

5. The mouse according to claim 1, wherein said operating module and said mouse body are arranged side by side, so that said operating members and said operating module are simultaneously exposed.

6. The mouse according to claim 1, wherein said operating module is a trackball device.

7. The mouse according to claim 1, wherein said operating module is a control rod.

8. The mouse according to claim 1, wherein said operating module is a touchpad.

9. The mouse according to claim 1, wherein said operating module is a solar energy charging pad.
